(19) United States
(12) Patent Application Publication
(10) Pub. No.: US 2011/0142227 A1
(43) Pub. Date: Jun. 16, 2011

(54) METHOD AND APPARATUS FOR ENCODING DATA AND METHOD AND APPARATUS FOR DECODING DATA

(75) Inventors: Sun-nam LEE, Suwon-si (KR); Hee-jae PARK, Hwaseong-si (KR); So-young LEE, Hwaseong-si (KR); Ji-young MOON, Hwaseong-si (KR); Ki-hun LEE, Jeonju-si (KR)

(73) Assignee: SAMSUNG ELECTRONICS CO., LTD., Suwon-si (KR)

(21) Appl. No.: 12/784,062

(22) Filed: May 20, 2010

(30) Foreign Application Priority Data
Dec. 14, 2009 (KR) 10-2009-0124003

(51) Int. Cl. H04L 9/28

(52) U.S. Cl. 380/28

(57) ABSTRACT

A method and apparatus for encoding data, and a method and apparatus for decoding data. The method of encoding data including generating first encoded data by encoding input data, dividing the first encoded data into a plurality of segments, and generating second encoded data by combining the plurality of segments and dummy data.

### CROSS-REFERENCE TO RELATED PATENT APPLICATION

This application claims priority from Korean Patent Application No. 10-2009-0124003, filed on Dec. 14, 2009, in the Korean Intellectual Property Office, the entire disclosure of which is incorporated herein in its entirety by reference.

### BACKGROUND OF THE INVENTION

1. Field of the Invention

The present invention relates to a method and apparatus for encoding data, and a method and apparatus for decoding data.

2. Description of the Related Art

When transferring data between devices, methods of encoding data are widely used to protect the transferred data.

One of the methods is a symmetrical key encoding method, wherein, when a device A has a security key, the device A transmits the security key to a device B, and the devices A and B transfer data encoded by using the security key.

Another method is a personal identification number (PIN) encoding method, wherein, when an access point (AP) has an intrinsic PIN, a user may input the PIN of the AP to a wireless terminal to be connected to the AP, thereby transferring encoded data, by using the PIN between the AP and the wireless terminal.

### SUMMARY

According to an exemplary embodiment, there is provided a method of encoding data, the method including: generating first encoded data by encoding input data; dividing the first encoded data into a plurality of segments; and generating second encoded data by combining at least the plurality of segments and dummy data.

In the second encoded data, the dummy data may be located between the plurality of segments.

The method may further include generating at least one of division information including information about the plurality of segments and combination information including information about locations of the plurality of segments.

The generating of the second encoded data may include changing an arranged order of the plurality of segments.

The method may further include generating verification data for checking integrity of the input data, wherein the generating of the second encoded data may include combining the plurality of segments, the dummy data, and the verification data.

The generating of the verification data may include extracting data located at a predetermined region of the verification data, and the combining of the plurality of segments, the dummy data, and the verification data may include combining the plurality of segments, the dummy data, and the extracted data.

A size of the dummy data may be the same as a size of the input data.

The second encoded data may be generated by allocating the dummy data between at least two of the plurality of segments so that the at least two of the plurality of segments are discontinuous.

According to an aspect of an exemplary embodiment, the method may further comprise transmitting the second encoded data to an apparatus for decoding data, wherein the transmitting comprises transmitting at least one of division information and combination information, the division information comprising information related to dividing the first encoded data and the combination information comprising information related to combining the plurality of segments and the dummy data.

According to another exemplary embodiment, there is provided a method of decoding data, the method including: obtaining second encoded data generated by combining a plurality of segments and dummy data, wherein the plurality of segments may be generated by dividing first encoded data; extracting the plurality of segments from the second encoded data; generating the first encoded data by combining the plurality of segments; and decoding the first encoded data.

In the second encoded data, the dummy data may be located between the plurality of segments.

The generating of the first encoded data may include determining an arranged order of the plurality of segments based on at least one of the division information and the combination information.

The second encoded data may include verification data for checking integrity of data, and the decoding of the first encoded data may include: extracting the verification data from the second encoded data; and checking the integrity of the first encoded data based on the verification data.

A size of the dummy data may be the same size as a size of the first encoded data.

According to another exemplary embodiment, there is provided an apparatus for encoding data, the apparatus including: a first generator for generating first encoded data by encoding input data; a divider for dividing the first encoded data into a plurality of segments; and a second generator for generating second encoded data by combining the plurality of segments and dummy data.

The second generator may generate the second encoded data by allocating the dummy data between at least two of the plurality of segments so that the at least two of the plurality of segments are discontinuous.

The apparatus for encoding data may further comprise a transmitter which transmits the second encoded data to an apparatus for decoding data, wherein the transmitter also transmits at least one of division information and combination information, the division information including information related to dividing the first encoded data and the combination information comprising information related to combining the plurality of segments and the dummy data

According to yet another exemplary embodiment, there is provided an apparatus for decoding data, the apparatus including: an obtainer for obtaining second encoded data generated by combining a plurality of segments and dummy data, wherein the plurality of segments are generated by dividing first encoded data; an extractor for extracting the plurality of segments from the second encoded data; a generator for generating the first encoded data by combining the plurality of segments; and a decoder for decoding the first encoded data.

The extractor may extract the plurality of segments from the second encoded dated based on at least one of division information and combination information, the division information including information related to how the first encoded data is divided and the combination information including information related to how the extracted plurality of segments and the dummy data are combined.

### BRIEF DESCRIPTION OF THE DRAWINGS

The above and other aspects will become more apparent by describing in detail exemplary embodiments thereof with reference to the attached drawings in which:

FIG. 1 is a block diagram of an apparatus for encoding data, according to an exemplary embodiment;

FIG. 2 is a block diagram of an apparatus for encoding data, according to another exemplary embodiment;

FIG. 3 is a block diagram of an apparatus for decoding data, according to an exemplary embodiment;

FIG. 4 is a diagram of a system including an apparatus for encoding data and an apparatus for decoding data, according to an exemplary embodiment;

FIG. 5 is a diagram for describing a data encoding process of the apparatuses of FIGS. 1 and 2, according to an exemplary embodiment;

FIG. 6 is a diagram for describing a data decoding process of the apparatus of FIG. 3;

FIG. 7 is a flowchart illustrating a method of encoding data, according to an exemplary embodiment; and

FIG. 8 is a flowchart illustrating a method of decoding data, according to an exemplary embodiment.

### DETAILED DESCRIPTION OF EXEMPLARY EMBODIMENTS

Hereinafter, exemplary embodiments will be described more fully with reference to the accompanying drawings, in which the exemplary embodiments are shown.

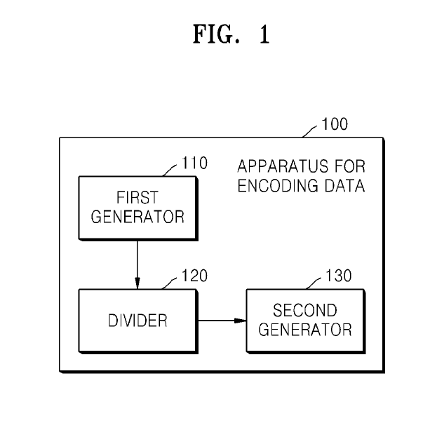

FIG. 1 is a block diagram of an apparatus 100 for encoding data, according to an exemplary embodiment.

The apparatus 100 includes a first generator 110, a divider 120, and a second generator 130.

The first generator 110 generates first encoded data by encoding input data. For convenience of description, an encryption key used to generate the first encoded data will now be referred to as a first encryption key. A type of the first encryption key may differ according to exemplary embodiments. For example, the first encryption key may be at least one of a hardware master key, a device unique key, and a software key.

The hardware master key is an intrinsic key according to a type of a device. Accordingly, devices having the same manufacturer, the same model name, and the same version may have the same hardware master key.

The device unique key is an intrinsic key according to a device. Accordingly, even if devices have the same manufacturer and the same model name, device unique keys thereof are different from each other.

The software key is an intrinsic key according to software used in a device.

The divider 120 divides the first encoded data into a plurality of segments. The number and size of the segments may differ according to exemplary embodiments. For example, the divider 120 may divide the first encoded data into two segments. Here, the size of the segments may be the same or different from each other.

The second generator 130 generates second encoded data by combining the segments and dummy data. The dummy data is irrelevant to encoding of the first encoded data, and prevents the input data or the first encoded data from being exposed to an unauthorized person. A method of generating the dummy data is not specifically limited, and a random value may be used as the dummy data. Specifically, the dummy data may be changed periodically so that it is difficult for an unauthorized person to obtain the input data. The size of the dummy data is not specifically limited, and may be identical to the size of the first encoded data.

The second generator 130 may be combine the segments and the dummy data so that it is difficult for an unauthorized person to obtain the input data.

For convenience of description, assume that AB denotes the first encoded data, A denotes a first segment in the first encoded data, B denotes a second segment in the first encoded data, and C denotes the dummy data.

The second generator 130 may generate the second encoded data by allocating the dummy data between the segments. In this case, the second encoded data may be denoted as ACB. Since the segments are discontinuously located in the second encoded data, it is difficult for an unauthorized person to obtain the input data.

The second generator 130 may change an arranged order of the segments. In other words, the first segment in the first encoded data may be a second segment in the second encoded data, and the second segment in the first encoded data may be a first segment in the second encoded data. In this case, the second encoded data may be denoted as BCA. Here, since the segments are discontinuously located in the second encoded data, it is difficult for an unauthorized person to obtain the input data.

The second generator 130 may generate the second encoded data by combining the segments and a plurality of pieces of the dummy data. Specifically, the second encoded data may be generated by dividing the dummy data into a plurality of segments, and then combining the segments of the dummy data and the segments of the first encoded data.

The apparatus 100 may further include a transmitter (not shown).

The transmitter transmits the second encoded data to an apparatus for decoding data. If methods of dividing and combining the first encoded data are not predetermined between the apparatus 100 and the apparatus for decoding data, the transmitter may transmit at least one of division information and combination information to the apparatus for decoding data. The division information is information about a method of dividing the first encoded data, and may include information about the number and size of the segments. The combination information is information about a method of combining the segments and the dummy data, and may include information about locations of the segments in the second encoded data.

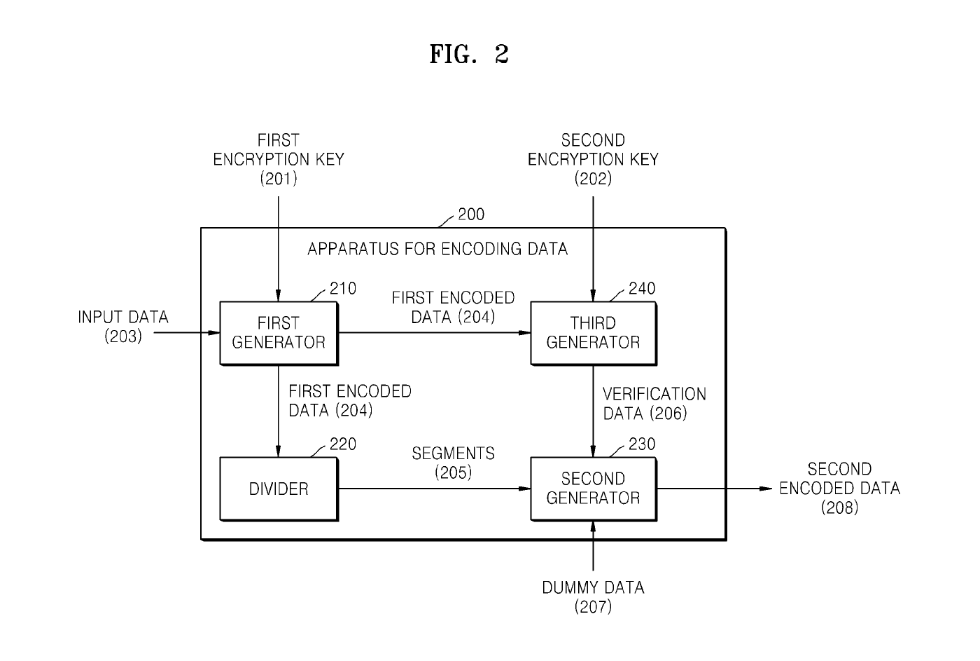

FIG. 2 is a block diagram of an apparatus 200 for encoding data, according to another exemplary embodiment.

The apparatus 200 includes a first generator 210, a divider 220, a second generator 230, and a third generator 240.

The first generator 210 generates first encoded data 204 by encoding input data 203 by using a first encryption key 201. The first encoded data 204 is transmitted to the divider 220 and the third generator 240.

The divider 220 divides the first encoded data 204 into a plurality of segments 205, and the segments 205 are transmitted to the second generator 230.

The third generator 240 generates verification data 206 for determining whether the first encoded data 204 or the input data 203 has been modulated. The third generator 240 generates the verification data 206 for verifying the integrity of the input data 203 or the first encoded data 204 by using an integrity verification algorithm. The third generator 240 may use at least one of cipher-based message authentication code (CMAC), keyed-hash MAC (KHMAC), hash MAC (HMAC), and secure hash algorithm (SHA), as the integrity verification algorithm. However, any integrity verification algorithm may be used as long as modulation of data may be determined.

In FIG. 2, the first encoded data 204 is input to the third generator 240. Accordingly, the verification data 206 generated by the third generator 240 may be used to verify the integrity of the first encoded data 204. However, if the input data 203 is input to the third generator 240, the verification data 206 generated by the third generator 240 may be used to verify the integrity of the input data 203.

The third generator 240 generates the verification data 206 by using a second encryption key 202. The second encryption key 202 may be at least one of a hardware master key, a device unique key, and a software key. Specifically, the second encryption key 202 may be identical to or different from the first encryption key 201.

The third generator 240 transmits the verification data 206 to the second generator 230. The third generator 240 may transmit all or a part of the verification data 206 to the second generator 230. For example, when the size of the verification data 206 generated by the third generator 240 is 16 bytes, the third generator 204 may transmit only 4 lower bytes of the verification data 206 to the second generator 230.

The second generator 230 generates second encoded data 208 by combining the segments 205, dummy data 207, and the verification data 206. Here, by allocating the dummy data 207 or the verification data 206 between the segments 205, the segments 205 may be discontinuously located in the second encoded data 208. Alternatively, the second generator 230 may discontinuously locate the segments 205 in the second encoded data 208 by changing an arranged order of the segments 205.

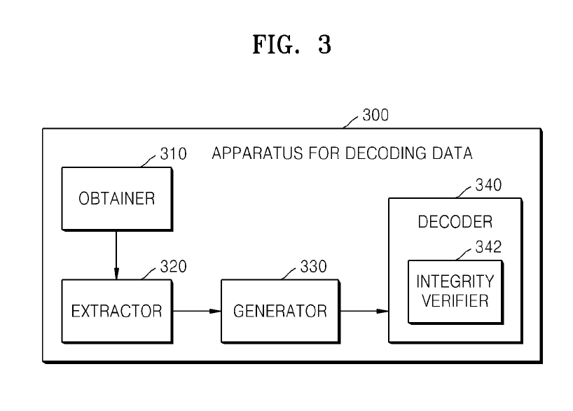

FIG. 3 is a block diagram of an apparatus for decoding data, according to an exemplary embodiment.

The apparatus 300 includes an obtainer 310, an extractor 320, a generator 330, and a decoder 340.

The obtainer 310 obtains second encoded data. The obtainer 310 may obtain the second encoded data through a wired or wireless network, or may read the second encoded data from a storage space for storing data. The second encoded data is generated by combining dummy data into a plurality of segments generated by dividing first encoded data.

In the second encoded data, the dummy data may be located between the segments. In this case, the segments are discontinuously located in the second encoded data, and thus the first encoded data may be prevented from being exposed. Alternatively, an arranged order of the segments in the first encoded data and an arranged order of the segments in the second encoded data may be different from each other. In this case, the segments are also discontinuously located in the second encoded data, and thus the first encoded data may be prevented from being exposed.

The extractor 320 selectively extracts the segments from the second encoded data. The extractor 320 may extract the segments from the second encoded data based on at least one of division information about how the first encoded data is divided and combination information about how the segments and the dummy data are combined. The division information may include information about the number and size of the segments, and the combination information may include information about locations of the segments, the dummy data, and verification data.

If methods of dividing and combining the first encoded data are predetermined between the apparatus 100 or 200 and the apparatus 300, the apparatus 100 or 200 may not transmit the division information or the combination information to the apparatus 300. However, if the methods are not predetermined between the apparatus 100 or 200 and the apparatus 300, the apparatus 100 or 200 may transmit the division information and the combination information to the apparatus 300.

The generator 330 generates the first encoded data by combining the segments. The generator 330 may combine the segments based on the combination information.

The decoder 340 decodes the first encoded data. The decoder 340 may include an integrity verifier 342. The integrity verifier 342 determines whether data obtained by decoding the first encoded data or the first encoded data has been modulated.

The integrity verifier 342 extracts verification data from the second encoded data. For convenience of description, the verification data extracted from the second encoded data will now be referred to as first verification data. According to an exemplary embodiment, the extractor 320 may extract the verification data from the second encoded data, and transmit the extracted verification data to the integrity verifier 342.

The integrity verifier 342 generates verification data according to the integrity verification algorithm used by the apparatus 200. For convenience of description, the verification data generated by the integrity verifier 342 according to the integrity verification algorithm will now be referred to as second verification data. The integrity verifier 342 determines the integrity of the decoded data or the first encoded data by comparing the first and second verification data. In detail, when the first verification and the second verification data are different from each other, it is determined that the decoded data or the first encoded data has been modulated, and thus are not used. On the other hand, when the first verification data and the second verification data are the same, it is determined that the decoded data or the first encoded data has not modulated, and thus are used.

The apparatus 100 or 200 may generate the second encoded data by combining the segments and all of the verification data generated by using the integrity verification algorithm, or by combining the segments and a part of the verification data generated by using the integrity verification algorithm. When the second encoded data is generated by combining the segments and all of the verification data, the integrity verifier 342 compares all of the second verification data and the first verification data, and when the second encoded data is generated by combining the segments and a part of the verification data generated by using the integrity verification algorithm, the integrity verifier 342 extracts a part of the second verification data, and compares the extracted part of the second verification data and the first verification data.

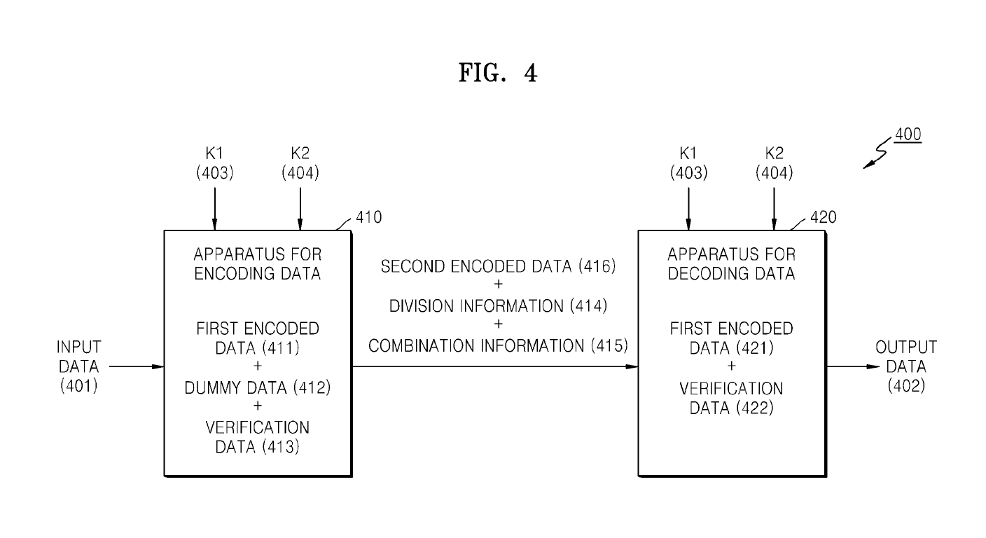

FIG. 4 is a diagram of a system 400 including an apparatus 410 for encoding data and an apparatus 420 for decoding data, according to an exemplary embodiment.

The apparatus 410 generates first encoded data 411 by encoding input data 401 by using a first encryption key (K1) 403. Also, the apparatus 410 generates verification data 413 for verifying the input data 401 by using a second encryption key (K2) 404. The apparatus 410 divides the first encoded data 411 into a plurality of segments, and generates second encoded data 416 by combining the segments, dummy data 412, and the verification data 413. According to another exemplary embodiment, the apparatus 410 may divide the dummy data 412 and the verification data 413, and then generate the second encoded data 416 by using the divided dummy data 412 and the divided verification data 413.

The apparatus 410 transmits division information 414, combination information 415, and the second encoded data 416 to the apparatus 420. The division information 414 is information about a method of dividing the first encoded data 411, the dummy data 412, and the verification data 413, and may include information about the number and size of the segments. The combination information 415 is information about a method of combining the first encoded data 411, the dummy data 412, and the verification data 413, and may be information about locations of the first encoded data 411, the dummy data 412, and the verification data 413. In FIG. 4, the apparatus 410 transmits the division information 414 and the combination information 415 together with the second encoded data 416, but when the methods of dividing and combining are predetermined between the apparatuses 410 and 420, the apparatus 410 may only transmit the second encoded data 416 to the apparatus 420.

The apparatus 420 receives the second encoded data 416, the division information 414, and the combination information 415.

When the second encoded data 416 is received, the apparatus 420 extracts the segments and verification data 422 from the second encoded data 416 based on the division information 414 and the combination information 415. The apparatus 420 generates first encoded data 421 by combining the extracted segments. When the first encoded data 421 is generated, the apparatus 420 generates output data 402 by using the K1 403. The apparatus 420 generates verification data (not shown) by using the K2 404, and verifies the integrity of the output data 402 by comparing the generated verification data and the verification data 422 extracted from the second encoded data 416.

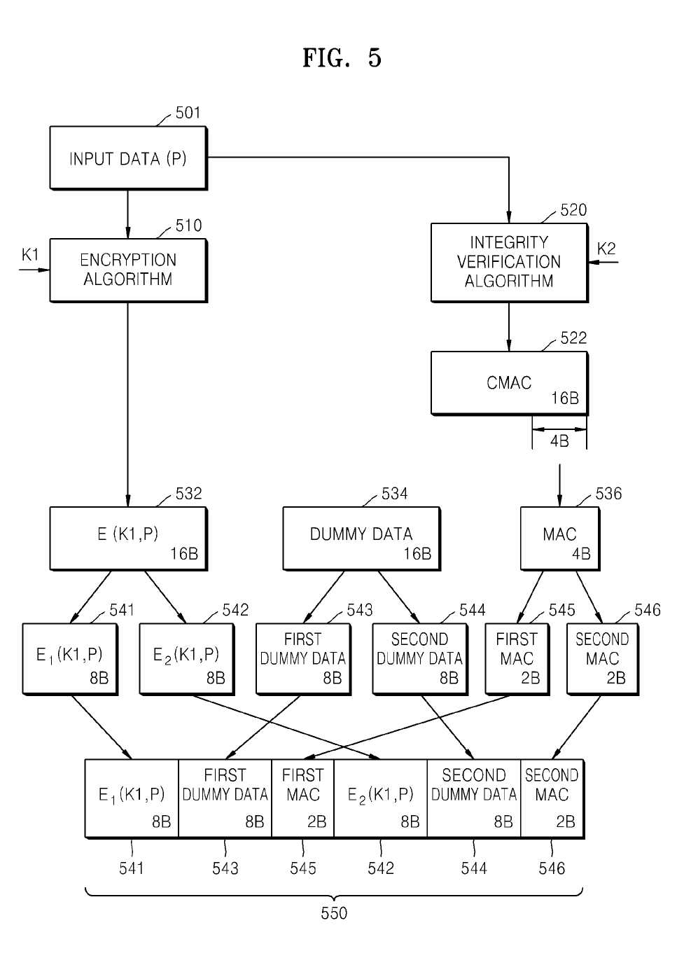

FIG. 5 is a diagram for describing a data encoding process of the apparatuses 100 and 200 of FIGS. 1 and 2, according to an exemplary embodiment.

Input data 501 is input to the apparatus 100 or 200.

The apparatus 100 or 200 encodes the input data 501 by using an encryption key K1. The input data 501 encoded by using the encryption key K1 will now be referred to as E(K1,P) 532. In FIG. 5, the size of the E(K1,P) 532 is 16 bytes.

The apparatus 100 generates CMAC 522 constituting verification data by using an encryption key K2. In FIG. 5, the size of the CMAC 522 is 16 bytes. The apparatus 100 or 200 extracts 4 lower bytes of the CMAC 522. The 4 lower bytes of the CMAC 522 will now be referred to as message authentication code (MAC) 536.

The apparatus 100 or 200 divides the E(K1,P) 532 into E1 (K1,P) 541 and E2(K1,P) 542, divides dummy data 534 into first dummy data 433 and second dummy data 544, and divides the MAC 536 into first MAC 545 and second MAC 546. In FIG. 5, in the present exemplary embodiment, the E(K1,P) 532, the dummy data 534, and the MAC 536 are divided into same size segments, but may be divided into different size segments according to another exemplary embodiment.

Accordingly, the sizes of the E1(K1,P) 541, the E2(K1,P) 542, the first dummy data 543, and the second dummy data 544 are each 8 bytes, and the sizes of the first MAC 545 and the second MAC 546 are 2 bytes.

The apparatus 100 or 200 generates second encoded data 550 by combining the E1(K1,P) 541, the E2(K1,P) 542, the first dummy data 543, the second dummy data 544, the first MAC 545, and the second MAC 546. Here, at least one of the first dummy data 543, the second dummy data 544, the first MAC 545, and the second MAC 546 is located between the E1(K1,P) 541 and the E2(K1,P) 542, so that the E1(K1,P) 541 and the E2(K1,P) 542 are discontinuously located.

According to another exemplary embodiment, the E1(K1,P) 541 is located at a lower byte of the second encoded data 550, and the E2(K1,P) 542 is located at an upper byte of the second encoded data 550, so that the E1 (K1,P) 541 and the E2(K1,P) 542 are non-sequentially located.

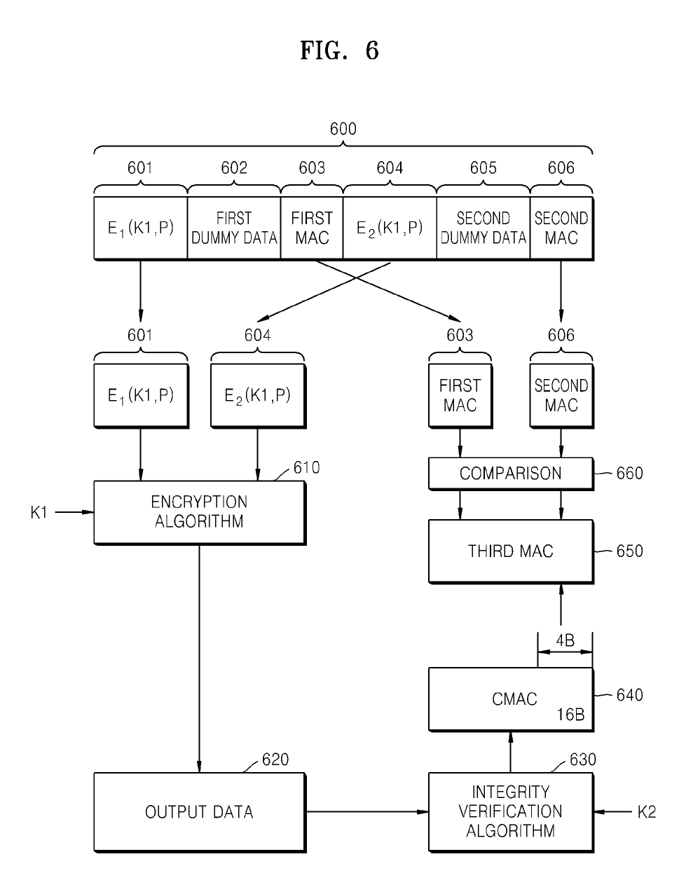

FIG. 6 is a diagram for describing a data decoding process of the apparatus 300 of FIG. 3.

The apparatus 300 obtains second encoded data 600.

With reference to the previous exemplary embodiment, E1(K1,P) 601 and E2(K1,P) 604 included in the second encoded data 600 may be generated by dividing the E(K1,P) 532, first dummy data 602 and second dummy data 605 may be generated by dividing the dummy data 534, and first MAC 603 and second MAC 606 may be generated by dividing the MAC 536.

The apparatus 300 extracts the E1(K1,P) 601 and the E2(K1,P) 604 from the second encoded data 600 based on division information and combination information, and generates the E(K1,P) 532 by using the E1(K1,P) 601 and the E2(K1,P) 604.

The apparatus 300 generates output data 620 by decoding the E(K1,P) 532 by using the encryption key K1.

The apparatus 300 generates CMAC 640 by using the encryption key K2. Here, the size of the CMAC 640 is 16 bytes, and the apparatus 300 extracts only 4 lower bytes of the CMAC 640. In FIG. 6, the 4 lower bytes extracted from the CMAC 640 are referred to as a third MAC 650.

The apparatus 300 extracts the first MAC 603 and the second MAC 606 from the second encoded data 600 based on the division information and the combination information. Then, the MAC 536 is obtained by combining the first MAC 603 and the second MAC 606, and the integrity of the output data 620 is verified by comparing the MAC 536 and the third MAC 650.

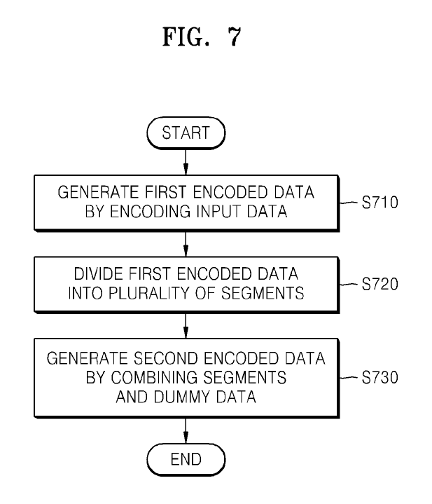

FIG. 7 is a flowchart illustrating a method of encoding data, according to an exemplary embodiment.

In operation S710, first encoded data is generated by encoding input data.

In operation S720, the first encoded data is divided into a plurality of segments.

In operation S730, second encoded data is generated by combining the segments and dummy data. Here, the second encoded data is generated in such a way that the dummy data is located between the segments. Accordingly, the segments may be discontinuously located in the second encoded data. Alternatively, an arranged order of the segments in the second encoded data may be changed so that the segments are discontinuously located in the second encoded data.

The second encoded data may further include verification data. The verification data is data for checking the integrity of the input data or the first encoded data. The second encoded data may include all of the verification data or a part of the verification data.

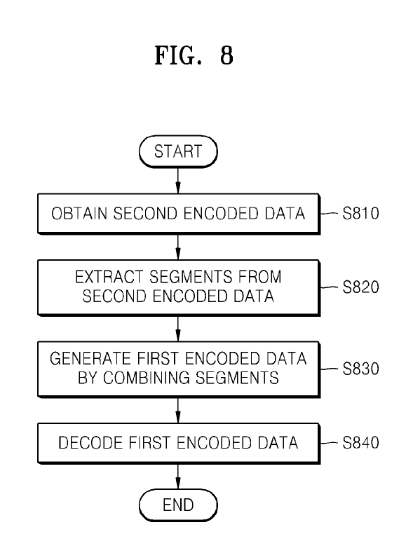

FIG. 8 is a flowchart illustrating a method of decoding data, according to an exemplary embodiment.

In operation S810, second encoded data is obtained. In the second encoded data, dummy data and a plurality of segments generated by dividing first encoded data are combined. According to an exemplary embodiment, the second encoded data may further include verification data for verifying the integrity of data decoded later.

In operation S820, the segments are extracted from the second encoded data. Here, the segments may be extracted from the second encoded data by using at least one of division information about a method of dividing the first encoded data and combination information about a method of combining the segments and the dummy data.

The verification data may be further extracted from the second encoded data in operation S820.

The first encoded data is generated by combining the segments in operation S830.

In operation S840, the first encoded data is decoded. According to an exemplary embodiment, the integrity of the decoded first encoded data may be verified by using the verification data extracted in operation S820.

The exemplary embodiments can be written as computer programs and can be implemented in general-use digital computers that execute the programs using a computer readable recording medium.

Examples of non-transitory computer readable recording medium include magnetic storage media (e.g., ROM, floppy disks, hard disks, etc.), optical recording media (e.g., CD-ROMs, or DVDs). Other types of computer readable recording medium can include storage media such as carrier waves (e.g., transmission through the Internet).

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of encoding data, the method comprising:
generating first encoded data by encoding input data;
dividing the first encoded data into a plurality of segments; and
generating second encoded data by combining at least the plurality of segments and dummy data.

2. The method of claim 1, wherein, in the second encoded data, the dummy data is located between the plurality of segments.

3. The method of claim 1, further comprising generating at least one of division information including information about the plurality of segments and combination information including information about locations of the plurality of segments.

4. The method of claim 1, wherein the generating of the second encoded data comprises changing an arranged order of the plurality of segments.

5. The method of claim 1, further comprising generating verification data for checking integrity of the input data, wherein the generating of the second encoded data comprises combining the plurality of segments, the dummy data, and the verification data.

6. The method of claim 5, wherein the generating of the verification data comprises extracting data located at a predetermined region of the verification data, and wherein the combining of the plurality of segments, the dummy data, and the verification data comprises combining the plurality of segments, the dummy data, and the extracted data.

7. The method of claim 1, wherein a size of the dummy data is the same as a size of the input data.

8. The method of claim 1, wherein the second encoded data is generated by allocating the dummy data between at least two of the plurality of segments so that the at least two of the plurality of segments are discontinuous.

9. The method of claim 1, further comprising transmitting the second encoded data to an apparatus for decoding data,
wherein the transmitting comprises transmitting at least one of division information and combination information, the division information comprising information related to dividing the first encoded data and the combination information comprising information related to combining the plurality of segments and the dummy data.

10. A method of decoding data, the method comprising:
obtaining second encoded data generated by combining a plurality of segments and dummy data, wherein the plurality of segments are generated by dividing first encoded data;
extracting the plurality of segments from the second encoded data;
generating the first encoded data by combining the plurality of segments; and
decoding the first encoded data.

11. The method of claim 10, wherein, in the second encoded data, the dummy data is located between the plurality of segments.

12. The method of claim 10, wherein the obtaining of the second encoded data comprises obtaining at least one of division information including information about the plurality of segments and combination information including information about locations of the plurality of segments in the second encoded data.

13. The method of claim 12, wherein the generating of the first encoded data comprises determining an arranged order of the plurality of segments based on at least one of the division information and the combination information.

14. The method of claim 10, wherein the second encoded data comprises verification data for checking integrity of data, and the decoding of the first encoded data comprises:
extracting the verification data from the second encoded data; and
checking the integrity of the first encoded data based on the verification data.

15. The method of claim 10, wherein a size of the dummy data is the same size as a size of the first encoded data.

16. An apparatus for encoding data, the apparatus comprising:
a first generator for generating first encoded data by encoding input data;
a divider for dividing the first encoded data into a plurality of segments; and
a second generator for generating second encoded data by combining the plurality of segments and dummy data.

17. The apparatus according to claim 16, wherein the second generator generates the second encoded data by allocating the dummy data between at least two of the plurality of segments so that the at least two of the plurality of segments are discontinuous.

18. The apparatus according to claim 16, further comprising a transmitter which transmits the second encoded data to an apparatus for decoding data,
wherein the transmitter also transmits at least one of division information and combination information, the division information including information related to dividing the first encoded data and the combination information comprising information related to combining the plurality of segments and the dummy data.

19. An apparatus for decoding data, the apparatus comprising:
an obtainer for obtaining second encoded data generated by combining a plurality of segments and dummy data, wherein the plurality of segments are generated by dividing first encoded data;
an extractor for extracting the plurality of segments from the second encoded data;
a generator for generating the first encoded data by combining the plurality of segments; and
a decoder for decoding the first encoded data.

20. The apparatus of claim 19, wherein the extractor extracts the plurality of segments from the second encoded dated based on at least one of division information and combination information, the division information including information related to how the first encoded data is divided and the combination information including information related to how the extracted plurality of segments and the dummy data are combined.

21. A non-transitory computer readable recording medium having recorded thereon a program for executing a method of encoding data, the method comprising:
generating first encoded data by encoding input data;
dividing the first encoded data into a plurality of segments; and
generating second encoded data by combining at least the plurality of segments and dummy data.

22. A non-transitory computer readable recording medium having recorded thereon a program for executing a method of decoding data, the method comprising:
obtaining second encoded data generated by combining a plurality of segments and dummy data, wherein the plurality of segments are generated by dividing first encoded data;
extracting the plurality of segments from the second encoded data;
generating the first encoded data by combining the plurality of segments; and
decoding the first encoded data.
